(19) United States
(12) Patent Application Publication
(10) Pub. No.: US 2023/0055106 A1
(43) Pub. Date: Feb. 23, 2023

(54) Method and Apparatus for Verification

(71) Applicant: Bottomline Technologies, Inc., Portsmouth, NH (US)

(72) Inventors: Omri Kletter, London (GB); Anirban Sinharoy, Newbury (GB); Danielle Nelson, Steamboat Springs, CO (US); Sandhya Pillalamarri, Acton, MA (US); Mohan Noothalapati, Bangalore (IN); Eric Choltus, Matthews, NC (US)

(73) Assignee: Bottomline Technologies, Inc., Portsmouth, NH (US)

(21) Appl. No.: 17/979,197

(22) Filed: Nov. 2, 2022

Related U.S. Application Data
(63) Continuation-in-part of application No. 16/246,076, filed on Jan. 11, 2019.

(51) Int. Cl. G06Q 20/40; G06Q 20/02

(52) U.S. Cl. CPC G06Q 20/4014; G06Q 20/02

(57) ABSTRACT

A device may verify the authorization of the payee by a payee identification server. A device may create a record in a database on the payee identification server, the record including, either directly or indirectly, payee identification information, payee address, payee phone number, payee tax information, one or more methods of payment accepted by the payee comprising a type of payment, institution information, and account information. A device may verify said record with one or more verification sources. A device may record the results of the verification in the record. A device may create a d-token to point to the record. A device may send the d-token to the payee. A device may receive, by the payee identification server, the d-token from a third party. A device may retrieve the one or more of the methods of the payment accepted by the payee.

### PRIOR APPLICATION

This application is a continuation-in-part of US Patent Publication US 2022-0245639A1, “Virtual Fraud Detection” by Peter Cousins, U.S. patent application Ser. No. 16/246076 filed on Jan. 11, 2019, hereby incorporated by reference in its entirety.

### BACKGROUND

### Technical Field

The present paper relates to database technologies, and, more particularly, to a method and apparatus for efficiently maintaining current, verified data.

### SUMMARY OF THE INVENTIONS

In some aspects, the techniques described herein relate to a method for verifying a payee, including: verifying authorization of the payee by a payee identification server; creating a record in a database on the payee identification server, the record including, either directly or indirectly, payee identification information, payee address, payee phone number, payee tax information, one or more methods of payment accepted by the payee including a type of payment, institution identification, and account information; verifying said record with one or more verification sources; recording results of the verification in the record; creating a d-token to point to the record; sending the d-token to the payee; receiving, by the payee identification server, the d-token from a third party; and retrieving the one or more of the methods of the payment accepted by the payee.

In some aspects, the techniques described herein relate to a method for verifying the payee further including sending a QR code to the payee, where the QR code contains a representation of the d-token.

In some aspects, the techniques described herein relate to a method 1 further including accepting a selection of the method of the payment from the payee.

In some aspects, the techniques described herein relate to a method 1 further including receiving instructions from the third party to reverify the record; and reverifying the record.

In some aspects, the techniques described herein relate to a method 1 further including reverifying the record after a predetermined period of time.

In some aspects, the techniques described herein relate to a method 1 further including using the one or more methods of the payment to effectuate a payment.

In some aspects, the techniques described herein relate to a method 1 further including returning the one or more methods of the payment to the third party.

In some aspects, the techniques described herein relate to a method 1 wherein the verification includes watchlist screening.

In some aspects, the techniques described herein relate to a method 1 wherein the verification includes a credit score.

In some aspects, the techniques described herein relate to a method 1 wherein the verification includes checking an account status.

In some aspects, the techniques described herein relate to a non-transitory computer-readable media programmed to: accept a sign-on request from a payee by a payee identification server; create a record in a database on the payee identification server, the record including, either directly or indirectly, payee identification information, payee address, payee phone number, payee tax information, one or more methods of payment accepted by the payee including a type of payment, institution identification, and account information; verify said record with one or more verification sources; record results of the verification in the record; create a d-token to point to the record; send the d-token to the payee; receive, by the payee identification server, the d-token from a third party; and retrieve the one or more of the methods of the payment accepted by the payee.

In some aspects, the techniques described herein relate to a non-transitory computer-readable media further programmed to send a QR code to the payee, where the QR code contains a representation of the d-token.

In some aspects, the techniques described herein relate to a non-transitory computer-readable media further programmed to accept a selection of the method of payment from the payee.

In some aspects, the techniques described herein relate to a non-transitory computer-readable media further programmed to receive instructions from the third party to reverify the record; and reverify the record.

In some aspects, the techniques described herein relate to a non-transitory computer-readable media further programmed to reverify the record after a predetermined period of time.

In some aspects, the techniques described herein relate to a non-transitory computer-readable media further programmed to use the one or more methods of the payment to effectuate a payment.

In some aspects, the techniques described herein relate to a non-transitory computer-readable media further programmed to return the one or more methods of the payment to the third party.

In some aspects, the techniques described herein relate to a non-transitory computer-readable media wherein the verification includes watchlist screening.

In some aspects, the techniques described herein relate to a non-transitory computer-readable media wherein the verification includes a credit score.

In some aspects, the techniques described herein relate to a non-transitory computer-readable media wherein the verification includes checking an account status.

For a better understanding of the present disclosure, together with other and further aspects thereof, reference is made to the following description, taken in conjunction with the accompanying drawings. The scope of the disclosure is set forth in the appended claims, which set forth in detail certain illustrative embodiments. These embodiments are indicative, however, of but a few of the various ways in which the principles of the disclosure may be employed.

### BRIEF DESCRIPTION OF THE DRAWINGS

FIG. 1 is an overview block diagram of the verification methodology.

FIG. 2 is a flow chart of the set up of a new record in the database.

FIG. 3 is a flow chart of a request for verified payment information.

FIG. 4 is a flow chart of the verification of the record.

FIG. 5 is a data structure in the database.

FIG. 6 is a possible list of the fields in a data structure in the database.

FIG. 7 is a diagram of one architecture of a system for implementing the verification methodology.

### DETAILED DESCRIPTION

The maintenance of verified data is an issue for a number of fields. First, the data must be verified, and then the verification must be maintained current as the original facts that led to verification change in the background. Consider a webpage. The webpage can be downloaded and databased locally to allow for efficient and prompt access. However, the webpage may change at the source, rendering the verified copy obsolete.

Similarly, a phone book application could compile a database of addresses and phone numbers that have been verified for accuracy. But people move and change their phone numbers, so techniques are needed to efficiently maintain the accuracy of the verified data.

Another industry that requires efficient access to current, verified data is the realm of payments. Payment fraud is a serious issue worldwide, and companies need to verify the destination of payments. Since a bank or payment processor may conduct millions of payments per day, the banks have a critical need to maintain current, verified data on the destination of the moneys involved in these payments.

In one embodiment, the application that is verifying the item (web page, phone book, payments, etc) calls an application program interface (API) to search for and retrieve the validated information. In another embodiment, a network message is sent to a software-as-a-service (SaaS) server to retrieve the information.

The SaaS or API could then provide one or more searches for the validated information. For instance, the payment application could search the database for a payee using the payee's name and address, and the validated information returned could include the customer's phone number, the contact person for the account, the account number, and the bank routing number as well as information on how confident the machine is on the validity of the banking information. In some embodiments, the search is performed on a plurality of databases, perhaps one database from the payor's own customers, a second database from the company providing the API or the SaaS server, and a third database of commercially available information from a public service such as Dun and Bradstreet. Once the information is retrieved, it may be stored in a single database to provide quicker and less expensive searches in the future.

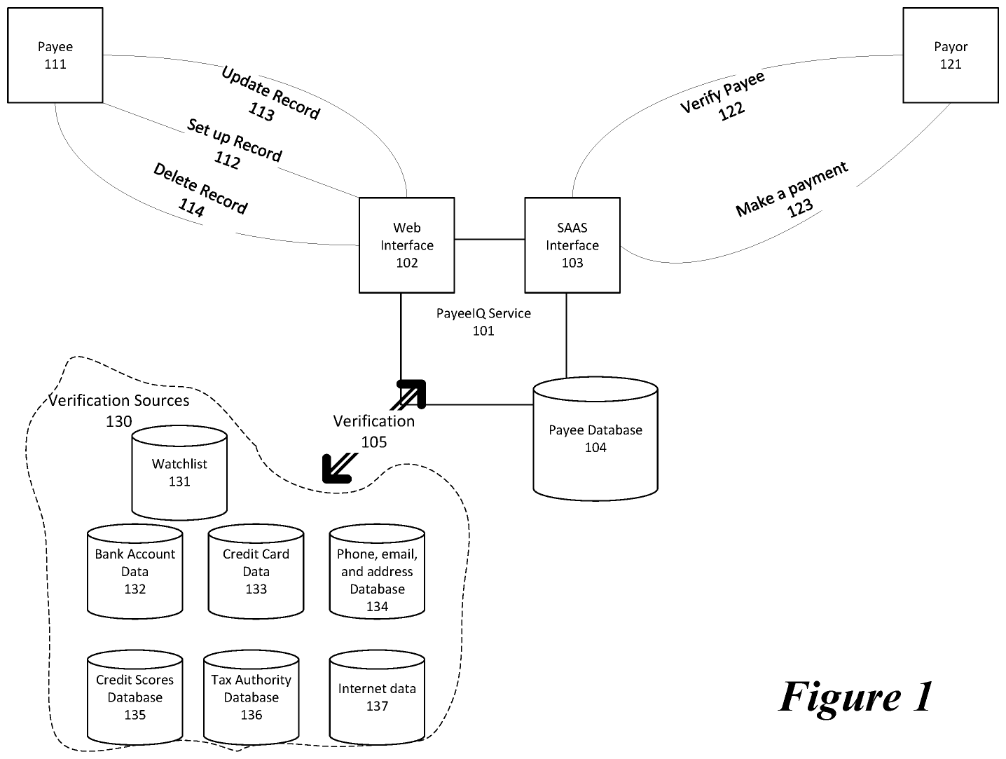

FIG. 1 is an overview of the software architecture of the verification system. The PayeeIQ software 101 provides the verification and the verified data by curating the data in a payee database 104. The data in the payee database 104 is loaded either through a web interface 102 or through a SAAS interface 103. In other embodiments, the payee database 104 could be loaded through an API or a file-based input. Other data is loaded or updated through the verification process 105, retrieving data from verification sources 130.

In one embodiment, a vendor, or payee 111 can set up record 112, placing information in the payee database 104 through the web interface 102. He can also update the record 113 or delete the record 114. In some embodiments, the PayeeIQ software 101 vendor charges the payee 111 to be included in the payee database 104. The improvement for the payee 111 is that inclusion in the payee database 104 makes it easier to be paid by the payee's 111 customers, or payor 121.

The payor 121 could also be charged by the PayeeIQ software 101 vendor, for the verified information on the payee 111. Payor 121 uses the system to verify the payee 122 by sending a message to the SAAS interface 103. In an alternative embodiment, payor 121 could request the verified data from the web interface 102, through an API, or through a file upload. In some embodiments, payor 121 could also set up record 112 or update record 113. In some embodiments, the payor 121 could make a payment 123 by sending a request to the PayeeIQ Service 101.

In one embodiment, the payor 121 could also instruct that the PayeeIQ software 101 make a payment from the payor 121 to the payee 111. This would be done by specifying a source (bank and account information) where the payor 121 wants the money taken from and the amount.

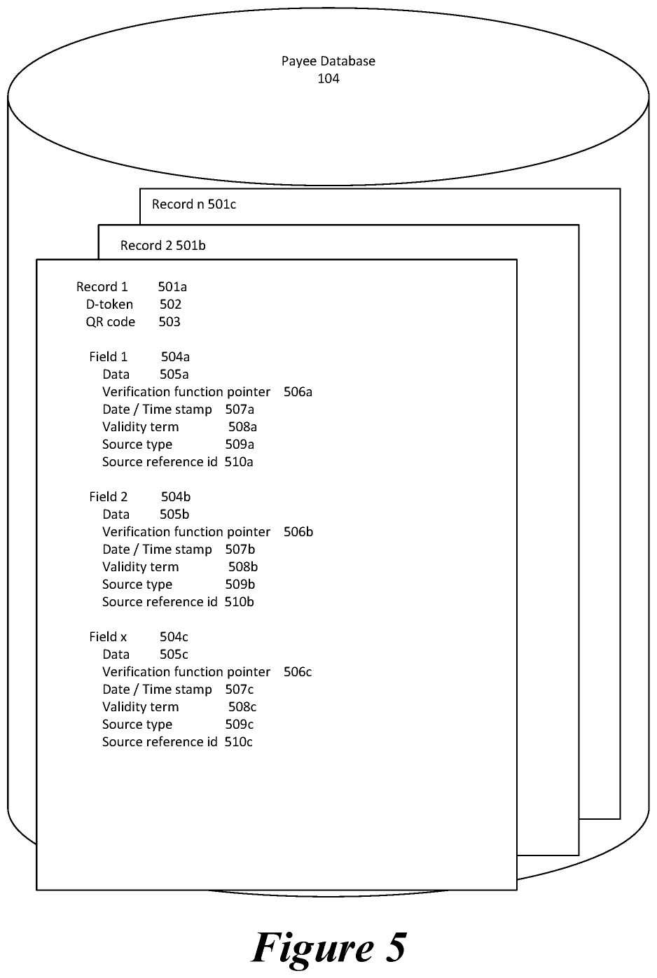

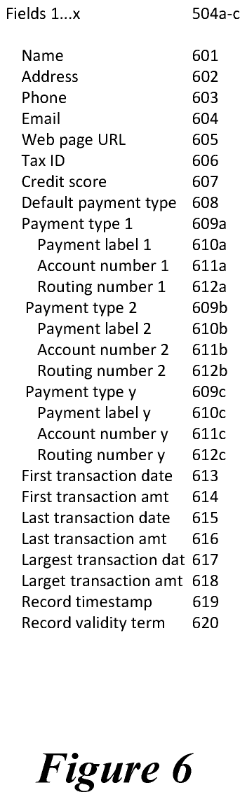

The information in the payee database 104 contains payee record 501a for each payee 111. This structure is explained further in FIG. 5 and FIG. 6. Information in the payee database 104 is verified 105 at various points in time by submitting requests to various verification sources 130. The verification sources 130 include:

Watchlist screening by comparing the payee record with a watchlist 131. To match the name in the record with the watchlist 131 records, a search is conducted. In some cases, the names in the payee database 104 record are slightly different, and special attention is required to find non-exact matches. The watchlist 131 screening could be done by a financial services company 708. In some embodiments, the search is performed using a Levenshtein distance algorithm to identify either the best match or a list of possible matches. See U.S. Pat. No. 11,163,955, “Identifying non-exactly matching text”, issued to Jessica Moran, et al on Nov. 2, 2021, incorporated herein by reference in its entirety. In another embodiment, an Elasticsearch is used to find the best match for the item information. See U.S. Pat. No. 11,238,053, “Two-step algorithm for non-exact matching of large datasets”, issued to Mark G. Kane, Richard J. Diekema, Jr., and Kaiyu Pan on Feb. 1, 2022, incorporated herein by reference in its entirety. In some embodiments, watchlist 131 screening is done for each request to verify the payee 122.

Bank account data 132 is verified by checking with the account database at specific bank 705 associated with the payee 111 (or at a clearing house database). In some instances, this is done by making a micro deposit, and in other embodiments, the check is done by requesting the status of the account from the bank 705. In some embodiments, account number 611a is not shared or directly exposed with payor 121 without certain clearances. For instance, a bank or other trusted financial institution may be able to retrieve the account number 611a but a convenience store payor 121 would not.

Credit card data 133 is verified by requesting a status from a credit card company 706.

Tax information could be found in a tax authority database 136, the tax authority database 136 managed by a tax authority 707. In many situations, payments need to be reported to a tax authority 707, so a payor 121 has an interest in verifying the tax information.

Phone, email, and address database 134 can also be used to verify the payee phone number, email, and address of the payee 111. A Levenshtein algorithm or Elasticsearch approach could be used to find non-exactly matching records. In some embodiments, this information could be available from a financial services company 708.

Credit scores database 135 could also be provided by the same or a different financial services company 708.

Internet data 137 could be provided by the financial services company 708 or from a standard web search.

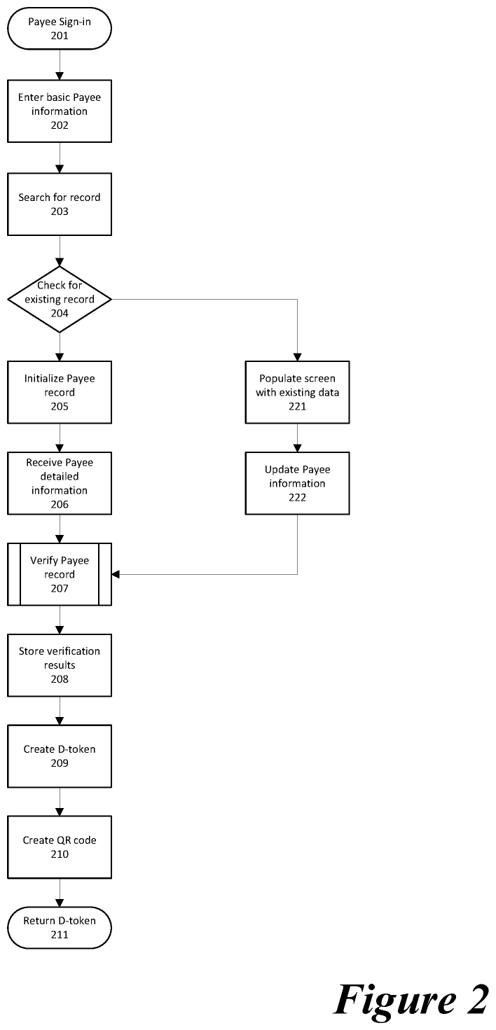

Turning to FIG. 2, we see a flow chart of the setup of a new record in the database. A record needs to be set up for each payee in the payee database 104. One way to set up the record is for a payee 111 to enter the data through the web interface 102. In this scenario, the payee 111 would sign in 201 to the PayeeIQ software 101 through the web interface 102. Payee 111 then enters basic information 202 about his organization, perhaps payee name 601 and payee address 602 or some other unique identifying information. If the payee 111 is trying to update record 113, then the d-token 502 (a d-token contains the payee identification information, and could be an index into the payee database 104 or any other alphabetic, numeric, binary, analog, or other encoding) or the QR code 503 may be entered. The identifying information is then used to search 203 the payee database 104 for a matching record. In some cases, such as when the QR code 503 or the d-token 502 are entered, the identifying information is an index in the database, allowing rapid access to the record, perhaps through a hash function. In other cases, the search requires either an exact search through a linear or hierarchical search algorithm, or a non-exact search through a Levenshtein or an Elastic search algorithm, as described above. The QR code could be one of many types of QR formats (e.g. iQR Code, SQRC Code, FrameQR code, HCC2D Code, QR Code Model 1 and 2, etc), and is not limited to any one of these formats. The QR code 503 could be replaced with a bar code, code 39, code 128, UPC, data matrix, pdf417, EAN, Interleaved 2 of 5, etc. in some embodiments.

If an existing record is found 204, then the web screen is populated 221 with the existing data from the record, and the payee 111 may update the information 222. The updated information is saved in the record.

If an existing record is not found 204, the payee 111 record is initialized 205. One aspect of the initialization may be the setting of all data/time stamps 507a,507b,507c to an invalid date or to the earliest date allowed in the computing system. Then the payee 111 enters the rest of the information 206 in the record, and the information is saved in the record. In some embodiments, the the payee 111 may enter only some of the information. In other embodiments, some or all of the fields are mandatory.

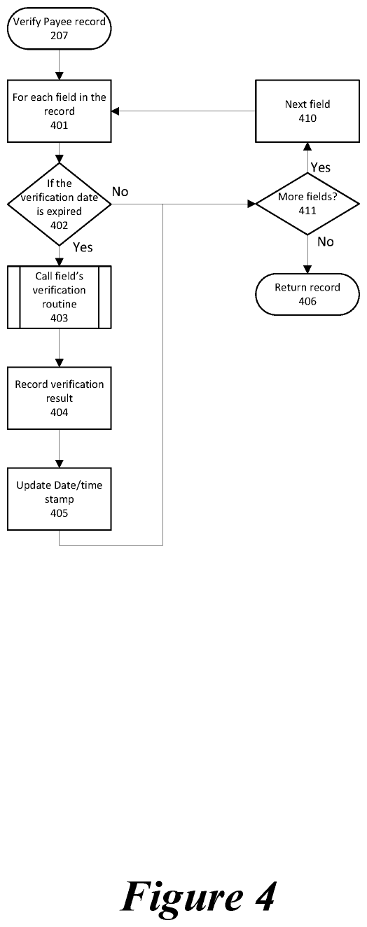

Once the record is populated, the payee record is verified 207. FIG. 4 and its corresponding description below show how the payee record may be verified. Once verified 207, the verification results are stored 208 in the record. In some cases, the information in the record may be updated based on the findings of the verification 207.

If this is a new record, a d-token is generated 209. If not, the d-token is retrieved for this record. Similarly, a QR code may be created 210 for the record or retrieved if the QR code already exists. Some embodiments do not use a QR code.

The d-token and the QR code, if it exists, are then sent 211 and/or displayed for the payee 111 to use when making payments.

In another embodiment, the payor 121 interface may be an application program interface (API) that allows a search of the payee database 104 to determine if a payee already exists there and return relevant and tiered information. A second API may search returns a list of potential matches and a limited number of fields 504a,504b,504c from the matching records 501a,501b,501c. A third API may return a confidence score regarding the viability of the payee 111. And a fourth API may request that the payee 111 be checked and that a payment be made if the payee 111 is verifiable.

Another embodiment may include a search function with a micro-front end that allows the user to search for a payee 111 based on the following potential fields: Beneficiary name 601 (in which it can be an individual or company)—specifically registered to that bank account; D-token 502; tax identification number 606; and/or QR code 503.

In another API embodiment, an API call may include the payee name (person name or business name) 601; payee account number 611a,611b,611c; payee routing number 612a,612b,612c; email address 604; phone number 603; address 602; and a payment amount. The API response may include a risk score; risk indicators showing the reasons for the risk score; whether the account is closed or if closure is pending; if the account is flagged for fraud; if the account is on a watchlist 131; if the payment amount is an outlier; if the account has been inactive for more than a set amount of time, perhaps 13 months; If there is no match to payees in the payee database 104; if there is an insufficient activity in the payee record 501a; the account status; the account creation date (or the first transaction 613); and/or the most recent transaction 615 date.

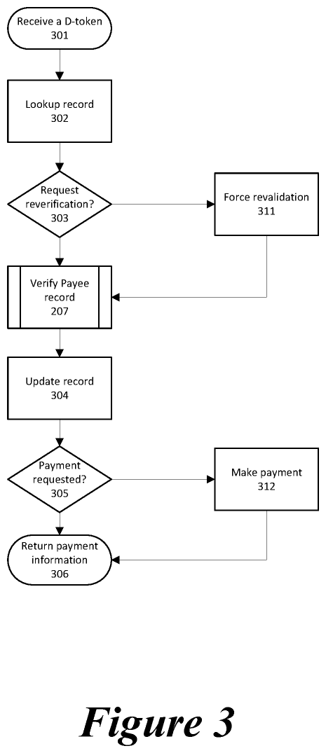

FIG. 3 is a flow chart of a request for verified payment information. A payor 121 receives the d-token or the QR code from the payee 111. The PayeeIQ software 101 receives 301 a request to verify a payee 111 from the payor 121. The request includes a d-token and may include a request to force the revalidation of various fields in the record. For instance, a payor 121 may request that a watchlist verification be performed regardless of when the previous watchlist field was verified.

The d-token is then used to look up 302 and retrieve the payee record. If reverification is requested 303 for any specific fields, then the date(s) for that field(s) is invalidated 311.

Next, the payee record is verified 207, as described in FIG. 4. Then, the record is updated 304 with the verification information.

In some embodiments, the payor 121 can request that the PayeeIQ software 101 also make the payment. In these embodiments, the request for verification also includes an amount and banking (or credit) information specifying where to take the money from. If payment is requested 305, then the PayeeIQ software 101 makes the payment 312 by sending the payor 121 payment instructions 123 along with the verified payee 111 information retrieved from the payee database 104. This payment may be contingent upon certain verification criteria from the payor 121 or upon criteria from the vendor of the PayeeIQ software 101.

Upon completion, the payment information and any verification issues are returned 306 to the payor 121.

FIG. 4 shows the details of the verification of the record 207. Essentially, the verification involves looping through 401 each field of the record. If the date/time stamp is valid and not expired, check if there are more fields 411. If there are more fields, then get the next field 410, and loop again 401.

If there are no more fields, return the record 406 to the calling routine along with the verification results.

If the verification date of the field has expired 402 or if the verification date is invalid, then the verification subroutine for the field is called 403. The verification routine returns a result that is recorded 404, and the data/time stamp is updated to the current date and time 405. Next, check to see if there are more fields 411 to review.

The verification routines 506a are stored as function pointers in the payee record 501a,501b,501c in the payee database 104, as seen in FIG. 5. We will focus on a single payee record 510a, but the structure of the other record 501b,501c could have the same structure.

The payee record 501a has a d-token 502 and may have a QR code 503. The payee record 501a has a plurality of fields 504a,504b,504c. A list of possible fields is seen in FIG. 6. Each field 504a (and 504b, 504c) has data 505a, a verification function pointer 506a, a date/date/date/time stamp 507a, and a validity term 508a. The validity term 508a could be a constant, a system-wide editable value for that field, or could be varied based on the reliability of the payee described in the record. The validity term 508a specifies a predetermined period of time when the data will time out.

Revalidation=if (CurrentTime>(DateTime Samp+Validity term))

The date/time stamp 507a contains the date and time when the data was last validated. The data 505a is the data associated with the field 504a. The data could be any data structure, such as a character, a string, a number, a Boolean, etc., and could also be a data structure, such as a plurality of strings representing address, city, state, country, and postal code.

The verification function pointer 506a could be a pointer to the function to validate the data in the field 504a. FIG. 6 contains a list of possible fields. The name 601, address 602, phone 603 and email address 604 may all use a validation routine that sends a SAAS request to a financial services company 708 to look up the name 601, address 602, phone 603, and email address 604 in the address database 134. The validation routine may return a confidence score for the match based on a Levenshtein distance algorithm. In some embodiments, this confidence score maybe 1.00 if the match is exact, 0.00 if no match was found, and various values in between if a partial match was found. The data from the address database 134 may be returned so that the record may be updated if desired.

The source type 509a may contain information on the database from which the data 505a was verified. For instance, name 601 and address 602 information exists in the watchlist 131, bank account data 132, and the phone, email, and address database 134. Source type 509a contains which source was used to verify the data 505a. The field 504a could also include a source reference id 510a field that holds further information on a record id in the source type 509a database.

The name 601, address 602, and phone 603 may also be verified through a financial services company 708 to check the watchlist 131. The verification routine may return a watchlist score (perhaps from 0.00 to 1.00) indicating how closely the name 601, address 602, and phone 603 match an entry on the watchlist 131. In another embodiment, the watchlist score could be compared to a watchlist threshold, and the verification routine could return a Boolean indication of a match (above the threshold) or no match (below the threshold).

The web page URL 605 for the payee 111 could have a verification routine that accesses the web page 605 for the payee record 501a and parses the website for name, address, and phone number. In some embodiments, the web page is run through a machine learning algorithm to determine an industry classification for the web page and to compare this classification to an industry classification of the payor 121 to make sure the payment is going to a related the payee 111. This verification is described in further detail in US Patent Publication US 2022-0245639 A1, “Virtual Fraud Detection” by Peter Cousins, U.S. patent application Ser. No. 16/246076 filed on Jan. 11, 2019, hereby incorporated by reference in its entirety.

The verification routine for the payee tax information 606 could include code to search a government database 136 to see if the payee tax information 606 matches the company name. For instance, the US Security and Exchange Commissions EDGAR database has the EIN tax number for all US Public companies. The verification routine could return a match/no match value.

Similarly, the credit score 607 could be retrieved for the payee 111 from a credit scores database 135 maintained by a financial services company 708. In some embodiments, the payee 111 would not enter their credit score, but this could be uploaded from the credit scores database 135 and monitored for significant changes by the verification routine.

The payee 111 may set a default payment type 608. This field is not verified, and is set by the the payee 111. Without the specification of the default payment type 608, the first payment type 609a may be used.

The payee 111 may enter a number of different payment types 609a,609b,609c, each with a payment label 610a, an account number 611a, and a routing number 612a (used for a financial institution identification). In some embodiments, only the default payment type 608 is verified; in other embodiments, all payment types 609a,609b,609c are verified. The payment label 610a may be a user-specified name, e.g “Company Travel Expenses Account” or the payment label 610a may specify the type of payment, e.g “VISA”, “AmEx”, “Chase Bank ACH”, “Deutsche Bank SWIFT”. The account number 611a may be a credit card number or a bank account number. The routing number 612a may be a bank code to designate the bank in which to deposit a payment. The verification routine for the payments may involve querying a bank or credit card company for the status of an account, and may involve requesting the date of the first transaction 613 on the account, the amount of the first transaction 614, the date of the most recent transaction 615, the amount of the most recent transaction 616, the date of the largest transaction 617, and the amount of the largest transaction 618. These six values come from the bank or credit card company and are recorded in the payee record 501a. The verification routine may check to see if the amount of the first transaction 613 or the date of the first transaction 614 have changed or if the largest transaction 618 has significantly changed.

In some embodiments, the payee record 501a could also include a field 504a specifying the date and time when the record was last verified 619. The payee record 501a may also have a record validity term 620 that specifies when the record needs to be revalidated.

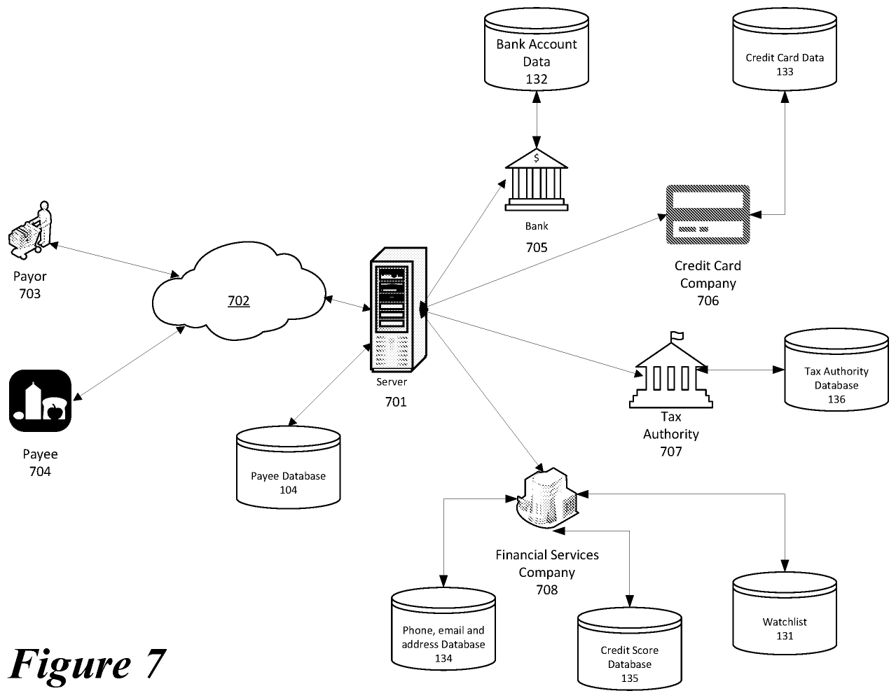

Looking to FIG. 7, one embodiment of the hardware architecture is presented. A payee identification server 701 is electrically (or wirelessly or optically) connected to a payee database 104. The payee database 104 could be one or more hard disk drives, CD ROMs, solid-state drives, magnetic tapes, EEPROM, or similar devices. The server 701 is a computing device that is connected to the payee database 104, a network 702, and to various verification sources 130. The server 701 could have memory, storage, processors, network interfaces, display screens, keyboards, and other input devices. The server 701 could include non-transitory computer-readable media programmed to implement the PayeeIQ software. The server 701 could be cloud based or on the premises of a financial institution, of a financial services company 708, of a bank, or of a payor 121, or of a payee 111.

The network 702 could be a payment rail, a local area network, a virtual network, or the internet. The connection between the server 701 and the verification sources 130 could be the same network 702 or a different payment rail, a local area network, a virtual network, or the internet. The network 702 could be connected to one or more banks 705 and/or one or more payors 703 and payees 704. In some embodiments, the verification sources 130 include one or more banks 705 connected to bank account data 132, one or more credit card companies 706 connected to credit card data 133, one or more tax authorities 707 connected to tax authority databases 136, and one or more financial services companies 708 connected to watchlist databases 131, address databases 134, and/or credit scores databases 135.

Although the inventions are shown and described with respect to certain exemplary embodiments, it is obvious that equivalents and modifications will occur to others skilled in the art upon the reading and understanding of the specification. It is envisioned that after reading and understanding the present inventions those skilled in the art may envision other processing states, events, and processing steps to further the objectives of the system of the present inventions. The present inventions include all such equivalents and modifications, and is limited only by the scope of the following claims.

The present inventions are now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer-readable media accessible to the processor, or a combination of a hardware circuit(s) and a processor or control block of an integrated circuit executing machine-readable code encoded within a computer-readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer-readable media, or a combination of a hardware circuit(s) and a processor and/or control block executing such code.

1. A method for verifying a payee, comprising:
verifying authorization of the payee by a payee identification server;
creating a record in a database on the payee identification server, the record including, either directly or indirectly, payee identification information, payee address, payee phone number, payee tax information, one or more methods of payment accepted by the payee comprising a type of payment, institution identification, and account information;
verifying said record with one or more verification sources;
recording results of the verification in the record;
creating a d-token to point to the record;
sending the d-token to the payee;
receiving, by the payee identification server, the d-token from a third party; and
retrieving the one or more of the methods of the payment accepted by the payee.

2. The method for verifying the payee of claim 1 further comprising sending a QR code to the payee, where the QR code contains a representation of the d-token.

3. The method of verifying the payee of claim 1 further comprising accepting a selection of the method of the payment from the payee.

4. The method of verifying the payee of claim 1 further comprising receiving instructions from the third party to reverify the record; and reverifying the record.

5. The method of verifying the payee of claim 1 further comprising reverifying the record after a predetermined period of time.

6. The method of verifying the payee of claim 1 further comprising using the one or more methods of the payment to effectuate a payment.

7. The method of verifying the payee of claim 1 further comprising returning the one or more methods of the payment to the third party.

8. The method of verifying the payee of claim 1 wherein the verification includes watchlist screening.

9. The method of verifying the payee of claim 1 wherein the verification includes a credit score.

10. The method of verifying the payee of claim 1 wherein the verification includes checking an account status.

11. A non-transitory computer-readable media programmed to:
accept a sign-on request from a payee by a payee identification server;
create a record in a database on the payee identification server, the record including, either directly or indirectly, payee identification information, payee address, payee phone number, payee tax information, one or more methods of payment accepted by the payee comprising a type of payment, institution identification, and account information;
verify said record with one or more verification sources;
record results of the verification in the record;
create a d-token to point to the record;
send the d-token to the payee;
receive, by the payee identification server, the d-token from a third party; and
retrieve the one or more of the methods of the payment accepted by the payee.

12. The non-transitory computer-readable media of claim 11 further programmed to send a QR code to the payee, where the QR code contains a representation of the d-token.

13. The non-transitory computer-readable media of claim 11 further programmed to accept a selection of the method of payment from the payee.

14. The non-transitory computer-readable media of claim 11 further programmed to receive instructions from the third party to reverify the record; and reverify the record.

15. The non-transitory computer-readable media of claim 11 further programmed to reverify the record after a predetermined period of time.

16. The non-transitory computer-readable media of claim 11 further programmed to use the one or more methods of the payment to effectuate a payment.

17. The non-transitory computer-readable media of claim 11 further programmed to return the one or more methods of the payment to the third party.

18. The non-transitory computer-readable media of claim 11 wherein the verification includes watchlist screening.

19. The non-transitory computer-readable media of claim 11 wherein the verification includes a credit score.

20. The non-transitory computer-readable media of claim 11 wherein the verification includes checking an account status.
